(19) United States
(12) Patent Application Publication
(10) Pub. No.: US 2006/0202600 A1
(43) Pub. Date: Sep. 14, 2006

(54) Lamp and method of manufacturing same

(75) Inventor: Klaus Eberhard Meinecke, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/566,547

(22) PCT Filed: Jul. 19, 2004
(86) PCT No.: PCT/IB04/51251

§ 371 Date: Jan. 27, 2006

(30) Foreign Application Priority Data
Aug. 1, 2003 (EP) 03102398.9

(51) Int. Cl. H01J 5/48; H01J 5/50

(52) U.S. Cl. 313/318.01

(57) ABSTRACT

A lamp, a headlight, and a method of manufacturing a lamp are described. The fixation of a burner 12 in a lamp base 14 is preceded by an alignment in conventional motor vehicle lamps, such that a burner element L will occupy an exactly defined position. In order to obtain an exact alignment in a lamp of simplified construction, it is suggested that the lamp base comprises position reference elements 22a, 22b, 22c at which contact surfaces are formed by bulk removal or plastic deformation such that they occupy a given position with respect to the burner element L.

The invention relates to a lamp and to a method of manufacturing a lamp, as well as to a headlight.

Known lamps, in particular in the field of automobiles, comprise a lamp base with a burner fastened therein. The burner comprises a burner element as the actual light-generating element. Besides conventional incandescent lamps (with an incandescent coil as the burner element), discharge lamps are also known in the field of automobiles, where a discharge arc in the discharge vessel forms the burner element.

An exact alignment of the lamp and thus an exact position of the burner element in a headlight is of major importance in particular for lamps used in automobiles. The light-generating element must be exactly in the correct position especially with the use of present-day flank profile reflectors. Lamps have position reference elements for positioning in a headlight. The position reference elements in known discharge lamps and incandescent lamps comprise three elevations on a flange of the lamp base. These position reference elements have upper contact surfaces by means of which the lamp is positioned in a reflector reference.

To obtain an exact alignment of the burner element relative to the contact surfaces of the position reference elements, it is known in the manufacture of lamps to align the burner first inside the lamp base before being fastened thereto. Comparatively expensive connections are necessary, however, to obtain a retention of a burner by a lamp base which is capable of alignment. The actual aligning step itself represents a further considerable expenditure.

EP-A-434 155 shows a motor vehicle front lamp. The lamp base comprises reference elements for positioning in a reflector. A burner is connected to a retention member which is telescopically coupled to a connection member. The burner can be aligned relative to the reference elements of the lamp base by these means.

It is an object of the invention to provide a lamp, a headlight, and a method of manufacturing a lamp, wherein an exact alignment of the burner element is possible in spite of a simple construction.

This object is achieved by a lamp as claimed in claim 1, a headlight as claimed in claim 5, and a method as claimed in claim 6. Dependent claims relate to advantageous further embodiments of the invention.

It is provided according to the invention that contact surfaces are formed at the position reference elements by machining or permanent deformation such that they have a given position with respect to the burner element. The special feature in comparison with known lamps is thus that the exact alignment of the burner element relative to the reference elements (contact surfaces) does not or at least not exclusively take place through an alignment of the burner with respect to the lamp base. Instead, the position reference elements are machined or permanently deformed at the lamp base itself such that the burner element is in an exact position with respect to these elements.

Accordingly, the manufacture of such a lamp is possible in that first the burner is fixedly fastened in the lamp base, for example by means of adhesion, fusion, locking, or injection molding. After the burner has been fastened, the lamp is aligned in that the position of the burner element relative to the position reference elements is determined, whereupon said elements are processed such that the envisaged alignment is achieved.

Such a lamp may be of a very simple construction. A complicated support of the burner in the lamp base with alignment possibility is no longer necessary. The construction is considerably simplified in particular in the case of burner elements that are aligned in more than three axes. The manufacturing process is also considerably simplified. An exactly aligned lamp may be manufactured, for example, by a simple, suitable milling-off of synthetic resin stubs or a plastic deformation of metal stubs in accordance with a measurement that was carried out first.

These advantages become apparent particularly in series production of a plurality of lamps. Within one series, several lamps are manufactured from identical lamp bases and burner elements. Small, unavoidable tolerances in the assembling process are compensated by a suitable processing of the reference elements. The lamps within the series will accordingly differ in respect of the shapes of the reference elements. The light-generating element (incandescent coil), however, will be in the same location for all lamps when incorporated in a reflector.

It is preferred that the lamp base is made at least partly of synthetic resin material and is manufactured in an injection molding process. The burner may then, for example, be also directly injection molded into the lamp base.

Alternatively, the lamp base may be made at least partly from metal. For example, if the reference elements are made of metal, the alignment may take place through plastic deformation of the references.

In a further embodiment of the invention, the position reference elements are made of synthetic resin material. The contact surfaces may then be formed by a bulk-removal operation, for example by milling or melting. It is particularly preferred that the lamp base is integrally formed with the position reference elements.

It is preferred that the burner is indetachably fastened in the lamp base without alignment possibility. The lamp base preferably comprises a flange from which the position reference elements project. These may be three synthetic resin stubs, for example in the case of discharge lamps. These synthetic resin stubs are initially made too large, whereupon they are partly removed again in dependence on the position of the burner fastened in the lamp base.

The headlight according to the invention comprises a lamp and a reflector. The lamp is provided in the reflector here such that the burner element lies inside the reflector. The lamp is positioned against the reflector by means of an abutment to at least its contact surfaces.

An embodiment of the invention will be explained in more detail below with reference to drawings, in which:

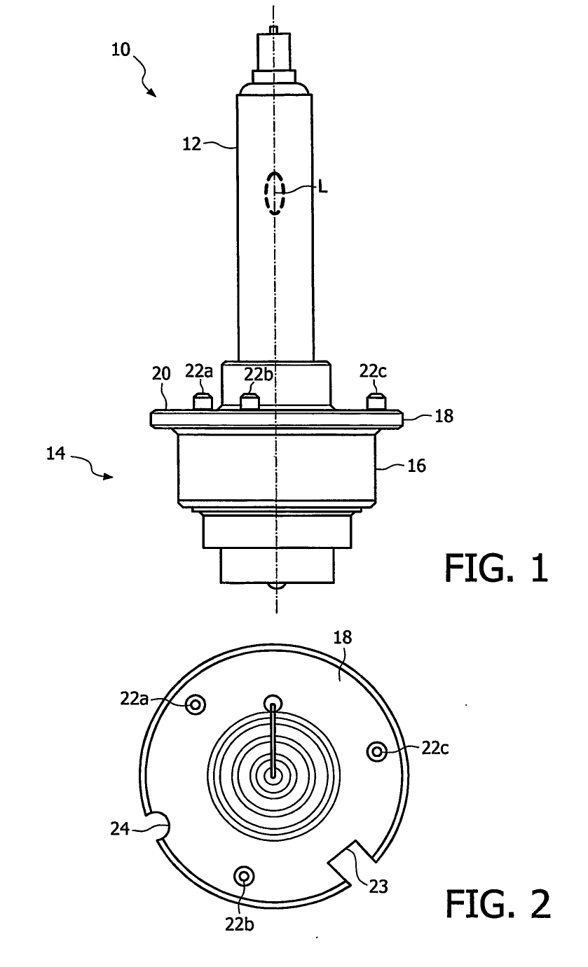

FIG. 1 is a side elevation of a lamp;

FIG. 2 is a front elevation of the lamp of FIG. 1;

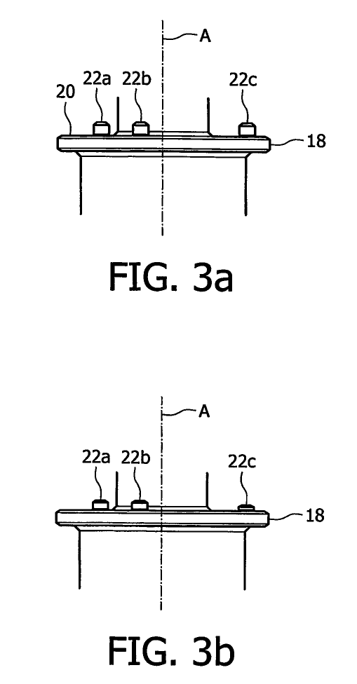

FIG. 3a is a side elevation of part of the lamp of FIG. 1 before processing; and

FIG. 3b is a side elevation of part of the lamp of FIG. 1 after processing.

FIG. 1 shows a lamp 10 in side elevation. This is a motor vehicle discharge lamp with a burner 12 which is fastened in a synthetic resin lamp base 14. The burner 12 comprises a discharge vessel L as the actual light-generating element.

The lamp base 14, see FIG. 2, is of an essentially circular cross-section. It comprises a lamp base body 16 with a flange 18 projecting laterally therefrom. Three reference elements 22a, 22b, 22c are formed on the upper side 20 of the flange 18. In addition, further reference elements 23, 24, visible in FIG. 2, are provided in the lamp base flange for protection against rotation about the longitudinal lamp axis and for locking purposes. The reference elements 22a, 22b, 22c are integrally formed from synthetic resin material together with the rest of the lamp base 14 in an injection molding process. The reference elements are arranged as small column-type projections on the surface 20 of the flange 18. In the lamp blank shown in FIG. 1, they have a height of several millimeters, for example 0.2 to 3 mm, preferably approximately 2 mm.

The burner 12 is made of glass, ceramic material, or quartz, and is accommodated in the lamp base 14. The burner 14 is fixedly, indetachably connected to the lamp base 14 without alignment possibility. Depending on the desired embodiment, the burner 12 may be directly injection molded in the injection molding process along with the lamp base 14, or the burner 12 may be inserted into an upper opening of the lamp base 14 and may be fixed therein, for example by riveting, by fusion, or by adhesion. It is similarly conceivable that a metal sleeve is fastened to the burner 12 and is welded to the lamp base 14 (not shown) by means of suitable connection tags.

The manufacture of the lamp 10 takes place such that first the lamp base 14 and the burner 12 are manufactured independently of one another. The burner 12 is then inserted into the lamp base 14 and fastened as described above. Although the manufacture takes place with a high degree of precision, the position of the light-generating element L relative to the contact surfaces (upper ends of the reference elements 22a, 22b, 22c) must be tested after the burner 12 and the lamp base 14 have been joined together. The lamp base 14 will lie with these three contact surfaces against a reflector housing upon a subsequent mounting of the lamp 10 in a reflector (not shown). The three contact surfaces, therefore, are the determining factor for the positioning of the lamp in three axes in the reflector.

To achieve an exact positioning of the light-generating element L in a reflector, the position of the element L relative to the three contact surfaces is fixedly prescribed. The actual position is tested by measurement. If the actual position corresponds to the prescribed position within a given tolerance range, the lamp can be left in this state.

The measurement and alignment of the lamp may relate to various axes. Three axes are considered in the present example, i.e. the tilting position of the lamp (two axes) and the shifting position along the longitudinal axis. Depending on the application, an alignment may also relate to more than these three axes and may take into account, for example, a shifting transversely to the longitudinal axis (a further two axes) or a rotation about the longitudinal axis. This is indeed not provided for in the example shown, but it may be achieved in a similar manner in that suitable reference elements (for example for the rotation of the reference element 23) are provided and are processed as necessary so as to achieve the corresponding positioning.

The reference elements 22a, 22b, 22c are purposely manufactured somewhat too large in the manufacture of the lamp base 14. The result of the measurement will thus usually be that one or several of the reference elements 22a, 22b, 22c is or are to be shortened so as to achieve the envisaged position.

The relevant process is shown in FIGS. 3a, 3b. FIG. 3a shows the three reference elements 22a, 22b, 22c in their original shape and size on the surface 20 of the flange 18. The measurement of the position of the light-generating element L now shows that the latter is situated too close to the ends of the reference elements 22a, 22b, 22c. This means that all three reference elements are to be shortened by a certain amount. If the measurement in addition shows, for example, that the element L is not present exactly on the central axis A, as defined by the three reference elements 22a, 22b, 22c, individual reference elements 22b, 22c may be shortened more strongly than the other one(s), so that the central axis A is tilted until the element L finally lies on this axis.

The shortening of the reference elements 22a, 22b, 22c may take place, for example, by means of milling or melting.

The result is visible in FIG. 3b. Whereas the reference element 22a was only slightly shortened, the element 22b was shortened more strongly and the element 22c even more strongly. The overall result is an axis A tilted in space, such that the element L lies on the axis A.

The above description of an embodiment related to a discharge lamp, but the invention may equally well be realized with a conventional incandescent lamp with a suitably constructed lamp base of metal or synthetic resin material.

1. A lamp with
a lamp base (14),
and a burner (12) with a burner element (L),
wherein the burner (12) is fixedly fastened in the lamp base (14),
and the lamp base (14) comprises position reference elements (22a, 22b, 22c) for positioning,
and wherein contact surfaces are formed at the position reference elements (22a, 22b, 22c) by machining or permanent deformation such that they have a given position with respect to the burner element (L).

2. A lamp as claimed in claim 1, wherein
the burner (12) is fastened in the lamp base (14) by means of injection molding, casting, adhesion, locking, or pressing.

3. A lamp as claimed in claim 1, wherein
the burner element (L) is a discharge vessel in which a gas discharge can be excited between two electrodes.

4. A lamp as claimed in claim 1, wherein
the lamp base (14) comprises a flange (18) from which the position reference elements (22a, 22b, 22c) project.

5. A headlight with
a lamp (10) as claimed in claim 1,
and a reflector,
wherein the lamp (10) is mounted to the reflector such that the burner element (L) is inside the reflector,
and wherein the lamp (10) is positioned with reference to the reflector through contact at least with the contact surfaces of the position reference element (22a, 22b, 22c).

6. A method of manufacturing a lamp with a lamp base (14) comprising position reference elements (22a, 22b, 22c) and with a burner (12) comprising a burner element (L), wherein
the burner (12) is fastened in the lamp base (14),
the position of the burner element (L) relative to the position reference elements (22a, 22b, 22c) is determined,
whereupon a machining operation or a permanent deformation is applied to the position reference elements (22a, 22b, 22c) such that contact surfaces are formed which define a given position with respect to the burner element (L).

7. A method as claimed in claim 6, wherein
the contact surfaces at the position reference elements (22a, 22b, 22c) are formed by a bulk-removing treatment, for example milling or melting.

8. A method as claimed in claim 6, wherein
the burner (12) is indetachably fastened in the lamp base (14) without alignment possibility.
